(19) United States
(12) Patent Application Publication
(10) Pub. No.: US 2012/0279339 A1
(43) Pub. Date: Nov. 8, 2012

(54) TILLER TRANSMISSION COMPRISING TWO CASCADE CONNECTED GEAR TRAINS

(76) Inventors: John Arthur Notaras, Lilyfield (AU); Angelo Lambrinos Notaras, Lilyfield (AU)

(21) Appl. No.: 13/511,083

(22) PCT Filed: Nov. 19, 2010
(86) PCT No.: PCT/AU2010/001544

§ 371 Date: Jul. 19, 2012

(30) Foreign Application Priority Data
Nov. 19, 2009 (AU) 2009905635

(51) Int. Cl. F16H 1/20

(52) U.S. Cl. 74/421 R; 74/425

(57) ABSTRACT

A transmission arrangement for an agricultural tiller is disclosed. Conventionally such a transmission has a reduction in the range of 30:1 to 50:1 and is realised by a worm drive gear (4) which meshes with a large driven spur gear (6). There is a large difference in sliding surface speeds which generates substantial heat loading to lubricant failure, This problem is overcome by two cascade connected different gear train arrangements (44A and 44B) formed by two spur gears (29, 30) having a reduction ratio of from 2:1 to 6:1, preferably 4:1, and a worm gear (34) and spur gear (39) having a reduction ratio of from 25:1 to 5:1, preferably 10:1. Both cascade connected gear trains are preferably positioned within a single sealed gear box enclosure (44) to minimise lubricant requirements. The spur gears can be sintered. Helical gears instead of spur gears are also disclosed.

### FIELD OF THE INVENTION

The present invention relates to agricultural tillers and, in particular, to garden tillers powered by a small internal combustion engine, or equivalent in power source, and intended to be operated by a single person.

### BACKGROUND ART

Such tillers have a substantially horizontal output shaft with tines secured thereto and which rotate at a relatively low speed with the shaft. The tiller disclosed in International Patent Application No. WO2006/128249 Notaras (Attorney Reference 2939P-D1-WO) is representative of this class.

Tillers are unusual garden implements because of the relatively low speed of the output shaft to which the tines are connected (typically about 150 rpm-250 rpm). This means that the garden tiller is required to have a speed reduction transmission which produces a substantial speed reduction (eg 50:1-30:1). This is to be contrasted with lawn mowers and whipper snipper or trimmer type implements which have no speed reduction (or a 1:1 ratio) and dedicated lawn edger type implements which can be direct drive or can have a speed reduction of up to about 4:1.

The petrol or gasolene engine used to power such tillers has an operating speed of typically 6,000-7,500 rpm under load. Since the tiller has a throttle control, the operator utilizes this throttle control to keep the speed of the engine relatively constant and thus depending on the load either decreases or increases the speed of the engine.

International Patent Application No. PCT/AU2008/000291 Notaras (published under No. WO2008/113,101) (Attorney Ref. 2939V-WO) discloses such a tiller (in addition to other implements) powered either by such an internal combustion engine or, by an electric motor which is arranged to emulate the operating speed of the abovementioned gasolene engine. Thus if the electric motor is a so called “universal” electric motor, typically in the range of 800-2,000 watts, then it typically operates at 15,000-17,000 rpm at no load. However, the operating speed of such a universal motor slows under load but still remains very high, typically in the vicinity of 13,000-14,000 rpm.

Another type of electric motor is an induction motor which operates at near synchronous speed with very low slip at low loads and operates somewhat slower with an increased slip at higher loads. A two pole induction motor has a synchronous speed of 3,000 rpm for a 50 Hz supply and 3,600 rpm for a 60 Hz supply. A four pole induction motor has a synchronous speed of 1,500 rpm for a 50 Hz supply and a synchronous speed of 1,800 rpm for a 60 Hz supply.

The last mentioned PCT specification discloses that an appropriately arranged transmission can be included with such electric motors to enable them to have an output speed which is substantially the same as a gasolene engine, and thereby enable an electric motor power unit to be substituted for a gasolene engine power unit, and visa versa.

The transmission 1 of the first mentioned PCT specification is illustrated in FIG. 1 and takes to form of a driven shaft 2 having a clutch drum 3 at one end and a worm gear 4 at the other end. The worm drive gear 4 is meshed with a large driven spur gear 6 at the centre of which Is the output shaft 7 to which the tines of the tiller are attached. It will be seen that the driven shaft 2 is substantially perpendicular to the output shaft 7 so that the transmission 1 in addition to bringing about a desired speed reduction also brings about a desired change in the axis of rotation.

The desired reduction of the transmission 1 is in the range of from 30:1 to 50:1 and typically is approximately 40:1. As a consequence, the driven spur gear is a relatively large gear and has a diameter of approximately 75 mm. In order to provide a sufficiently rugged arrangement, the driven spur gear 6 is fabricated from bronze which must be initially cast, then machined in order to establish its centre and outside diameter, and finally gear out to create the approximately 40 gear teeth. This results in a very expensive spur gear.

The drive worm gear 4 is rotating at approximately 6,500-7,000 rpm whereas the output shaft 7 is rotating at approximately 150-250 rpm for a 50:1-30:1 range of gear reductions. Thus all combinations have a result that then Is a large difference in the sliding surface speeds between the two gears 4 and 6. As a consequence, there is an inherently high frictional load on the transmission 1 which leads to the creation of heat and high temperatures. The worm drive gear 4 and driven spur gear 6 must be Well lubricated and with home owner type domestic tillers the gears 4 and 6 are packed with grease as the lubricant. However, because of the high temperatures created by the high speed frictional worm teeth load, such lubricants can fail, especially with moderate to high use in the vicinity of 25 hours or so. Such lubricant failure results in failure of the transmission 1 and a major overhaul is required for the tiller. Searches for lubricants with adequate heat performances have so far proved fruitless.

Furthermore, the heat generated by the high sliding friction gear train formed by the worm drive gear 4 and the spur driven gear 6 means that some of the power created by the gasolene engine is wasted as heat. Thus the available power from the gasolene engine able to be delivered to the tines is reduced. Consequently, the high sliding friction in the transmission 1 reduces the available work able to be done by the tines.

Published US Patent Application No. US 2003/0178208 (Abenroth et al) discloses an electric garden tiller powered by an electric motor and having a multiple stage speed reduction arrangement. The first stage is a small drive gear 66 which is mounted directly to the motor shaft. The drive gear 66 engages a larger driven gear 68 and this arrangement has a 5.36:1 speed reduction. The driven gear 68 is attached to a shaft 72 having a worm gear 74 which in turn drives a spur gear 76. The spur gear 76 is attached to the tine shaft 78. The speed reduction between the worm gear 74 and the driven spur gear 76 is 32:1. As a consequence, the overall speed reduction of the multiple stage speed reduction arrangement is 5.35×32=171.52:1

Since a 1500 or 3000 rpm electric induction motor is much too slow for the power source, the electric motor disclosed in this patent application is presumably a universal motor having a speed range in the vicinity of 13,000-15,000 rpm. The abovementioned gear reduction ratio of 171.52 together with a universal motor results in the tine shaft 78 having a speed of from 76-87 rpm approximately. This is far too low to result in an adequate tilling action which requires a speed in excess of 120 rpm and typically approximately 150 to 250 rpm. It follows that the disclosure of this patent specification is not one which would relied upon by those skilled in the tilling arts.

Furthermore, the speed reduction of the worm drive, namely 32:1 means that there is a big difference in the sliding surface speed between the two gears 74 and 76 so that there is consequentially a high frictional heat generation which, as referred to above, results in lubricant failure with prolonged use at high load.

### GENESIS OF THE INVENTION

The genesis of the present invention is a desire to produce a tiller and a tiller transmission which substantially avoid a large difference in surface sliding speeds in a worm gear drive and therefore does not have high sliding friction. Consequently, the tiller transmission does not create heat sufficient to degrade the gear drive lubricant.

### SUMMARY OF THE INVENTION

In accordance with a first aspect of the present invention there is disclosed an agricultural tiller or like implement having a substantially horizontal output shaft with tines secured thereto and rotatable therewith, said tiller being powered by an internal combustion engine, or other power source, having a driven shaft which rotates about a drive axis which is substantially perpendicular to said output shaft, and a drive transmission interconnecting said driven shaft and said output shaft, wherein said drive transmission comprises two cascade connected different gear train arrangements having an overall speed reduction in the range of from 30:1 to 50:1, one of said gear train arrangements being a low friction gear train having a speed reduction in the range of from 2:1 to 6:1 and the other of said gear train arrangements being a worm gear having a speed reduction in the range of from 25:1 to 5:1.

In accordance with a second aspect of the present invention there is disclosed a tiller drive transmission comprising two cascade connected different gear train arrangements having an overall speed reduction in the range of from 30:1 to 50:1, one of said gear train arrangements being a low friction gear train having a speed reduction in the range of from 2:1 to 6:1 and the other of said gear train arrangements being a worm gear having a speed reduction in the range of from 25:1 to 5:1.

In accordance with a third aspect of the present invention there is disclosed a garden tiller having a transmission including a helix spur gear and a worm gear wherein said helix spur gear is fabricated by a sintering process.

### BRIEF DESCRIPTION OF THE DRAWINGS

A preferred embodiment of the present invention will now be described, by way of example only, with reference to the accompanying drawings in which:

FIG. 1 is a side elevational view of the transmission of a prior art tiller arrangement,

FIG. 2 is a similar view through the transmission of the preferred embodiment, and

FIG. 3 is a longitudinal cross-sectional view through the tiller housing showing the mounting of the transmission of FIG. 2.

### DETAILED DESCRIPTION

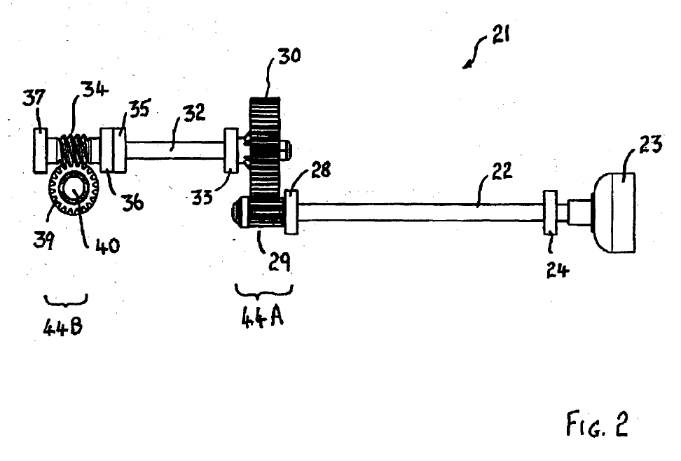

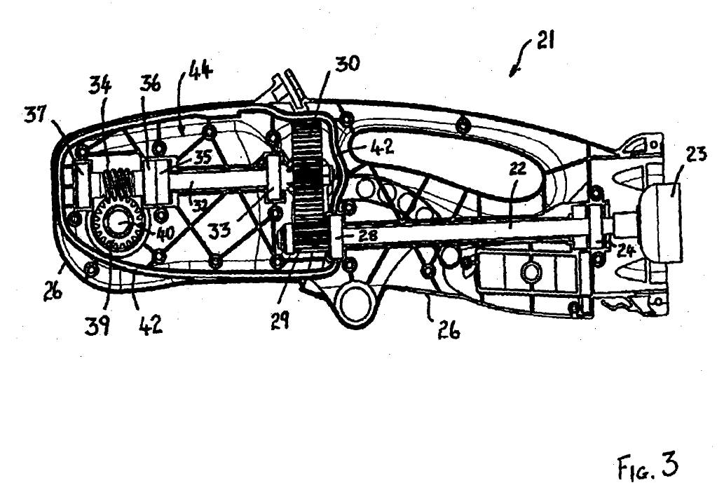

As seen in FIGS. 2 and 3, the transmission 21 of the preferred embodiment has a driven shaft 22 having a clutch drum 23 at one end, and a spur gear 29 at the other end within a first sub-region 44A (FIG. 2) of the double gear box enclosure 44. The enclosure is bounded by a seal 42 (FIG. 3). The clutch drum 23 is supported by a bearing 24, mounted in a longitudinally split moulded plastic housing 26 (only one half of which is illustrated in FIG. 3).

The other end of the driven shaft 22 is supported by a sealed bearing 28 adjacent the spur gear 29. The spur gear 29 meshes with a spur gear 30 carried by one end of an intermediate shaft 32 which is supported by a scaled bearing 33. The spur gears 29 and 30 and bearings 28 and 33 are within the first sub-region 44A of the double gearbox enclosure 44.

The other end of the intermediate shaft 32 carries, a worm gear 34 which is supported by three sealed bearings 35-37. The worm gear 34 meshes with a spur gear 39 carried by the output shaft 40 to which the tines (not illustrated) are connected. The bearings 35 to 37 and gears 34 and 40 are located within a second sub-region 44B of the double gear box enclosure 44.

The preferred speed reduction ratio of the low friction lower speed gear train formed by spur gears 29, 30 is in the range of from 2:1 to 6:1 and is preferably 4:1. The speed reduction ratio of the gear train formed by the worm gear 34 and the spur gear 39 is in the range of 25:1 to 5:1 and is preferably 10:1.

The selection of the abovementioned gear ratios is particularly important since the much lower rate of rotation of the worm gear enables the difference in surface speeds. of the gears incorporated in the worm drive to be relatively low, thereby substantially reducing the friction and heat generated in the worm drive arrangement which does not result in thermal decomposition of the lubricant. This low friction arrangement and its cool naming provide the necessary extended operating life for the prior art lubricant or enable less expensive and lower grade lubricants to be used.

Furthermore, the volume of grease required is relatively low since only a thin smear of grease is required on the gears 29 and 30 In the sub-region 44A because these gears are not heavily taxed. Also, only a small volume of grease needs be packed around the gears 34 and 39 in sub-region 44B because very little heat is generated thereby.

At first sight one would expect two cascade connected gear trains would be more expensive than a single gear train, however, this has not proved to be the case. In particular, because of the low rate of frictional heat generated between the two spurs 29 and 30, these gears can be fabricated from low cost mass produced plastics material and are therefore relatively inexpensive.

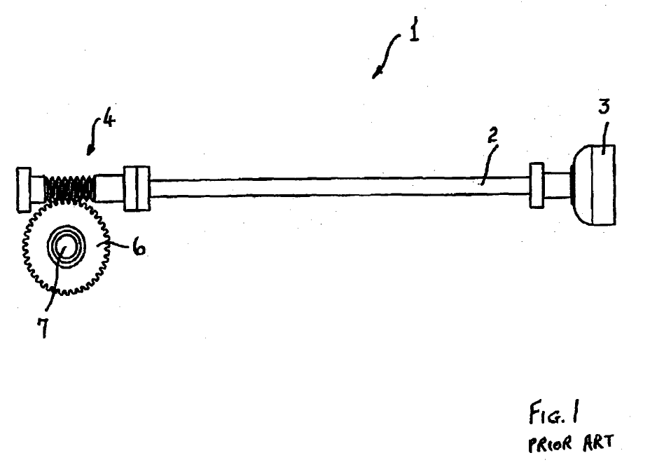

Also, the small diameter driven spur gear 39, because of its much lower mass and far fewer machined teeth, is much less expensive to manufacture than the large diameter and expensive driven spur gear 6 of FIG. 1. Furthermore, because of the large cost savings of the small driven spur gear 39, this cost saving outweighs the added costs of the additional low cost spur gears 29, 30 and the mounting thereof. The abovementioned reduction in the amount of friction as explained above substantially reduces the total amount of lubricant required within the gear train enclosure 44. With increasing crude oil prices, and hence grease prices, this can give rise to appreciable savings.

It follows from the foregoing that the modification of the worm drive from about 40:1 to about 10:1 reduces the relative difference between the surface speed of the meshing surfaces of the worm drive. This overcomes the heating problems previously experienced. Furthermore, the much lower cost of the above described worm drive embodiment enables manufacturing savings which more than compensates for the additional cost of the intermediate shaft 32, gears 29, 30 and their associated bearings.

The foregoing describes only one embodiment of the present invention and modifications, obvious to those skilled in the tilling arts, can be made thereto without departing from the scope of the present invention. For example, the spur gears 29, 30 and 39 can be replaced by helical gears having teeth arranged in helix fashion.

The term “comprising” (and its grammatical variations) as used herein is used in the

Inclusive sense of “including” or “having” and not in the exclusive sense of “consisting only of”.

1. An agricultural tiller or like implement having
a substantially horizontal output shaft with tines secured thereto and rotatable therewith, said tiller being powered by an internal combustion engine, or other power source, having a drive shaft which rotates about a drive axis which is substantially perpendicular to said output shaft, and
a drive transmission interconnecting said drive shaft and said output shaft, wherein said drive transmission comprises two cascade connected different gear train arrangements having an overall speed reduction in the range of from 30:1 to 50:1, one of said gear train arrangements being a low friction gear train having a speed reduction in the range of from 2:1 to 6:1 and the other of said gear train arrangements being a worm gear having a speed reduction in the range of from 25:1 to 5:1.

2. The tiller as claimed in claim 1 wherein said overall speed reduction is approximately 40:1, said low friction gear train speed reduction is approximately 4:1 and said worm gear speed reduction is approximately 10:1.

3. The tiller as claimed in claim 1 wherein said worm gear drives said output shaft.

4. The tiller as claimed in claim 1 wherein said low friction gear train comprises a pair of spur gears.

5. A tiller drive transmission comprising two cascade connected different gear train arrangements having an overall speed reduction in the range of from 30:1 to 50:1, one of said gear train arrangements being a low friction gear train having a speed reduction in the range of from 2:1 to 6:1 and the other of said gear train arrangements being a worm gear having a speed reduction in the range of from 25:1 to 5:1.

6. The tiller as claimed in claim 5 wherein said overall speed reduction is approximately 40:1, said low friction gear train speed reduction is approximately 4:1 and said worm gear speed reduction is approximately 10:1.

7. The tiller as claimed in claim 5 wherein said worm gear drives said output shaft.

8. The tiller as claimed in claim 5 wherein said low friction gear train comprises a pair of spur gears.

9. The tiller as claimed in claim 5 wherein said cascading gear train includes two spur gears, and a helix spur gear driven by a worm gear.

10. The tiller as claimed in claim 9 wherein the helix spur gear is made by a sintering powder process.

11. (canceled)

12. A garden tiller having a transmission including a helix spur gear and a worm gear wherein said helix spur gear is fabricated by a sintering process.
